(19) United States
(12) Patent Application Publication
(10) Pub. No.: US 2007/0258455 A1
(43) Pub. Date: Nov. 8, 2007

(54) SYSTEM FOR DISTRIBUTED ARCHITECTURE FOR MULTICAST ACCESS CONTROL

(75) Inventor: John Kaippallimalil, Richardson, TX (US)

Correspondence Address: AKIN GUMP STRAUSS HAUER & FELD, LLP, P O BOX 688, DALLAS, TX, 75313-0688, US

(73) Assignee: FutureWei Technologies, Inc.

(21) Appl. No.: 11/745,881

(22) Filed: May 8, 2007

Related U.S. Application Data
(60) Provisional application No. 60/798,506, filed on May 8, 2006.

(51) Int. Cl. H04L 12/56

(52) U.S. Cl. 370/390

(57) ABSTRACT

A method of multicast access control in an IP multicast system is disclosed. The method provides a distributed architecture separating a session control in a service stratum from an access control in a transport stratum.

### PRIORITY CLAIM

This application claims the priority benefit of U.S. Provisional Application No. 60/798,506, filed on May 8, 2006.

### TECHNICAL FIELD OF THE INVENTION

The present invention generally relates to multicast access control. Specifically, the present invention relates to a novel distributed architecture for multicast access control or Internet Protocol Television Services (IP-TV).

### BACKGROUND OF THE INVENTION

IP-TV is an emerging media and communications service of considerable interest, and is an integral part of triple play service offerings. Architectures that implement IP-TV are fast evolving. One consistent challenge in conventional technologies is that of channel zapping. It is a challenge to reduce the amount of time between channel changes, in Internet Group Management Protocol (IGMP) based control, as currently utilized in conventional IP-TV systems. Thus, conventionally, an IGMP decision proxy is placed as close to a user as possible (e.g., at an access node). In order to facilitate decisions regarding access control (i.e., which user has subscribed to a service), a control proxy that handles the session is also located at the access node (e.g., dsl.2006.326 WT-144 extensions, DSL Forum). This collocation of a control proxy with an access node introduces further challenges as IP-TV is increasingly utilized in increasingly dynamic control streams.

One considerable challenge may stem from the fact that collocation of a session control server with a bearer control does away with separation of control and bearer. Other challenge may arise, for example, when a terminal is mobile and an access node changes during the course of a session. In such instances, the relationship between control and bearer, and their inter-coupling, becomes increasingly complex and requires optimal coordination.

Therefore, there is a need for a system of constructs and methods to preserve separation of call and bearer, while optimizing quality levels for zapping control, in IP-TV applications. For IP-TV/multicast applications, the ability to maintain a session control server separate from a bearer control would be especially desirable.

### SUMMARY OF THE INVENTION

The present invention provides a system, comprising various methods and apparatus, for a distributed architecture design for multicast access control including IP-TV. The present invention provides a desirable system for zapping control in multicast access control including IP-TV while maintaining call and transport separation.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram depicting a system for a distributed architecture design in multicast access control according to the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

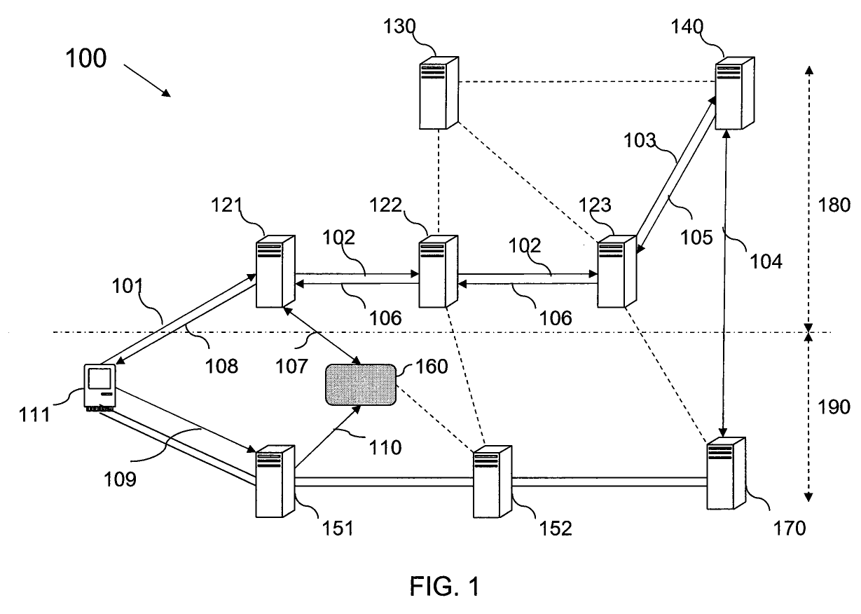

Certain aspects of the present invention are illustrated and describe now with reference to FIG. 1, a system 100 for a distributed architecture design in multicast access control according to the present invention is depicted. System 100 comprises a Service Stratum 180 and a Transport Stratum 190. Service Stratum 180 comprises a Proxy Call Session Control Function (P-CSCF) 121, an Interrogating Call Session Control Function (I-CSCF) 122, a Serving Call Session Control Function (S-CSCF) 123, a Home Subscriber Server (HSS) 130, and an Internet Protocol Television Application Service (IP-TV AS) 140. Transport Stratum 190 comprises an user (UE) 111, an access node or an access Border Gateway Function (AN/A-BGF) 151, an Interconnect Border Gateway Function (I-BGF) 152, a Resource and Admission control (RACS) 160, and an Media Resource Function Server (MRF) 170.

In FIG. 1, as UE 111 initiates an operation (e.g., turns on a TV), a Set-Top Box (STB) then sends a Session Initiation Protocol (SIP) INVITE request 101 to P-CSCF 121. This initiation communication may indicate the type of service required or requested by UE 111. For example, SIP INVITE request 101 may be sent with a Public Service Identifier (PSI) identifying an IP-TV Application Service (AS).

P-CSCF 121 forwards a corresponding indication communication (i.e., SIP INVITE request 102) to I-CSCF 122. I-CSCF 122 determines a serving node for a user/session and forwards SIP INVITE request 102 to S-CSCF 123.

S-CSCF 123 authenticates UE 111, and forwards a SIP INVITE request 103 to an IP-TV AS 140, based on initial filter criteria. Upon receiving SIP INVITE request 103, IP-TV AS 140 communicates a SIP INVITE request 104 with MRF 170, to determine whether content is being served by MRF 170, or another associated content server.

Then, IP-TV AS 140 attaches a new Content-Type fragment in a SIP response 105 indicating channels (multicast ports) that UE 111 has subscribed to. SIP response 105 may be a profiled group of channels/ports. Upon receiving SIP response 105 from IP-TV AS 140, S-CSCF 123 determines that no other applications apply in the initial filters, and forwards a SIP response 106 to I-CSCF 122, and then to P-CSCF 121.

P-CSCF 121 processes this information, and requests a Quality of Service (QoS) 107 for a session, via an interface to RACS 160. In addition, P-CSCF 121 conveys a list of multicast ports that UE 111 has permission to access. This process may be accomplished by extending a DIAMETER protocol or other protocols at the interface. P-CSCF 121 also communicates a response 108, including a program guide (multicast channels), over to UE 111.

When UE 111 selects a channel during communication with AN/A-BGF 151, AN/A-BGF 151 communicates 110 with RACS 160, and checks to ensure that UE 111 has appropriate access authorization or permissions. Then AN/A-BGF 151 constructs a multicast tree and forwards a channel to UE 111.

In certain embodiments, multicast access control decision information per subscriber may be maintained or kept in a service stratum. In an IP-TV application, for example, this may be addressed through the use of an IP-TV application server (AS). Other embodiments may convey access control information, from an application server, to a session control server in charge of proxying for resources using a new Session Initiation Protocol (SIP) fragment. Other embodiments may implement DIAMETER or other protocols so that when a session control proxy receives an access control list, the session control proxy conveys the access control list to a resource control subsystem. In various embodiments, an IPv4 or an IPv6 multicast may be applied in the distributed architecture as depicted in FIG. 1. Moreover, extensions to DIAMETER protocol may be implemented to support transferring of multicast access control information.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of providing multicast access control in an IP multicast system, comprising the steps of:
providing a system architecture having a service stratum and a transport stratum;
providing session control in the service stratum; and
providing access control in the transport stratum.

2. The method according to claim 1, wherein the step of providing session control in the service stratum further comprises providing an application server communicating access control, related to a plurality of multicast addresses, to the transport stratum.

3. The method according to claim 2, wherein the plurality of multicast addresses comprise a Session Initiation Protocol fragment.

4. The method according to claim 3, wherein the Session Initiation Protocol fragment comprises an IPv4 multicast address information.

5. The method according to claim 3, wherein the Session Initiation Protocol fragment comprises an IPv6 multicast address information.

6. The method according to claim 1, wherein a resource and access control protocol is utilized to support transfer of access control information.

7. The method according to claim 6, wherein the resource and access control protocol is a DIAMETER protocol.

8. A system for multicast access control in an IP multicast system, comprising:
a service stratum;
a transport stratum;
a session control operable in the service stratum; and
an access control operable in the transport stratum.

9. The system according to claim 8, wherein the service stratum comprises an application server, communicating access control related to a plurality of multicast addresses, to the transport stratum.

10. The system according to claim 9, wherein the plurality of multicast addresses comprise a Session Initiation Protocol fragment.

11. The method according to claim 10, wherein the Session Initiation Protocol fragment comprises an IPv4 multicast address information.

12. The method according to claim 10, wherein the Session Initiation Protocol fragment comprises an IPv6 multicast address information.

13. The method according to claim 8, wherein a resource and access control protocol is utilized to support transfer of access control information.

14. The method according to claim 13, wherein the resource and access control protocol is a DIAMETER protocol.

15. A method of separating a session control in a service stratum from an access control in a transport stratum in an IP-TV system, comprising the steps of:
sending an SIP INVITE request to a Proxy Call Session Control Function from a Set-Top Box by a user;
forwarding the SIP INVITE request to an Interrogating Call Session Control Function from the Proxy Call Session Control Function;
forwarding the SIP INVITE request to an Serving Call Session Control Function from the Interrogating Call Session Control Function;
authenticating the user in the Serving Call Session Control Function;
ensuring content is being served by a content server in an IP-TV Application Server;
forming an SIP response indicating channels that the user has subscribed to in the IP-TV Application Server;
forwarding the SIP response to the Proxy Call Session Control Function the Serving Call Session Control Function;
requesting a Quality of Service (QoS) and an admission control in the Proxy Call Session Control Function;
sending the SIP response to the user by Proxy Call Session Control Function; and
forwarding a channel to the user from an access node.

16. The method according to claim 15, wherein a resource and access control protocol is utilized to support transfer of access control information.

17. The method according to claim 16, wherein the resource and access control protocol is a DIAMETER protocol.
